(19) United States
(12) Patent Application Publication
(10) Pub. No.: US 2013/0114072 A1
(43) Pub. Date: May 9, 2013

(54) SOLAR CELL INSPECTION METHOD AND APPARATUS THEREOF

(71) Applicants: TSUN-YI WANG, (US); MING-CHIEH LIN, (US)

(72) Inventors: TSUN-YI WANG, (US); MING-CHIEH LIN, (US)

(73) Assignee: CHROMA ATE INC.

(21) Appl. No.: 13/288,941

(22) Filed: Nov. 3, 2011

(51) Int. Cl. G01J 1/42

(52) U.S. Cl. 356/218

(57) ABSTRACT

A solar cell inspection method and apparatus are disclosed. An embodiment of the solar cell inspection method includes the steps of: charging a diffusion capacitance of a solar cell; after charging the diffusion capacitance, discharging the diffusion capacitance; and detecting light emitted by the solar cell during the discharging step.

### BACKGROUND

1. Technical Field

The invention relates generally to a solar cell inspection method and apparatus, and more particularly, to a solar cell inspection method and apparatus that applies the physical phenomenon of electroluminescence (EL).

2. Related Art

Because solar cells are a relatively cleaner source of energy, it is expected that the popularity and penetration rate of solar cells will keep rising in the foreseeable future.

The fabrication process of solar cells is relatively complicated. Because of the complicity, finished solar cells frequently have defects, such as micro-cracks. These defects will affect the cells' quality by reducing the cells' light-electricity transformation efficiency and life.

As a result, manufacturers of solar cells are devoted to enhance fabrication technology to reduce defects on finished solar cells. In addition, before sending shipments to their customers, the manufacturers also have to inspect the finished solar cells to ensure the cells' quality. This inspection can not only reduce future costs associated with warranty and repair, but also increase the customers' satisfactory.

Minority carrier diffusion length and minority carrier lifetime are two important parameters of a solar cell. The relationship between these two parameters is: DL=(D*τ)^{1/2}. In other words, τ=DL²/D. As used in the equations, DL is the diffusion length, D is the diffusion coefficient or diffusivity, and τ is the lifetime. If a point on a solar cell has a relatively shorter diffusion length DL, the point likely has inferior quality. In other words, the point may have a defect unobservable by human eyes, may not contribute current normally, and may have a higher probability of fracture in the future. Therefore, inspecting the diffusion lengths on different points of a solar cell is one way to value the quality of the solar cell.

Electron beam induced current (EBIC) and laser beam induced current (LBIC) are two physical phenomena that can be applied to inspect the diffusion lengths of a solar cell, so as to value to the quality of the solar cell. However, these kinds of inspection methods are not only costly but also time-consuming. In addition, they must use huge inspection machines. As a result, these kinds of inspection methods are not suitable for practical application. Furthermore, other inspection methods that apply the theory of electroluminescence (EL) have low discriminating power and hence cannot discern minor variations in diffusion lengths.

### BRIEF SUMMARY

The invention provides embodiments of a solar cell inspection method and apparatus; the embodiments have relatively higher discrimination power, simpler system structures, and lower inspection costs. These embodiments are very valuable to the solar cell industry.

Two embodiments of a solar cell inspection method are disclosed. In a first embodiment, the method includes the steps of: charging a diffusion capacitance of a solar cell; after charging the diffusion capacitance, discharging the diffusion capacitance; and detecting light emitted by the solar cell during the discharging step.

In a second embodiment, the method includes the steps of: applying a forward DC bias across a solar cell; after applying the forward DC bias, applying a reverse DC bias across the solar cell; and detecting light emitted by the solar cell when the reverse DC bias is being applied.

An embodiment of a solar cell inspection apparatus is also disclosed. In the embodiment, the apparatus includes a charging/discharging module and a light detection module. The charging/discharging module is operative to first charge and then discharge a diffusion capacitance of a solar cell. The light detection module is operative to detect light emitted by the solar cell when the charging/discharging module is discharging the diffusion capacitance.

In contrast to the inspection methods that apply the theory of EBIC or LBIC, the aforementioned embodiments are more suitable for practical application because they have lower inspection costs, higher inspection speeds, and better discriminating power, and require inspection machines of smaller volumes. In contrast to other inspection methods that apply the theory of EL, the aforementioned embodiments have better discriminating power and hence can more precisely discern defects on solar cells.

Other features of the present invention will be apparent from the accompanying drawings and from the detailed description which follows.

### BRIEF DESCRIPTION OF THE DRAWINGS

The invention is fully illustrated by the subsequent detailed description and the accompanying drawings, in which like references indicate similar elements.

FIG. 1 shows a block diagram of a solar cell inspection apparatus according to an embodiment of the invention.

FIG. 2 shows a block diagram of the charging/discharging module shown in FIG. 1 according to an embodiment of the invention.

FIG. 3 shows a timing diagram that illustrates a solar cell inspection method according to an embodiment of the invention.

FIG. 4 shows a timing diagram that illustrates a solar cell inspection method according to another embodiment of the invention.

### DETAILED DESCRIPTION

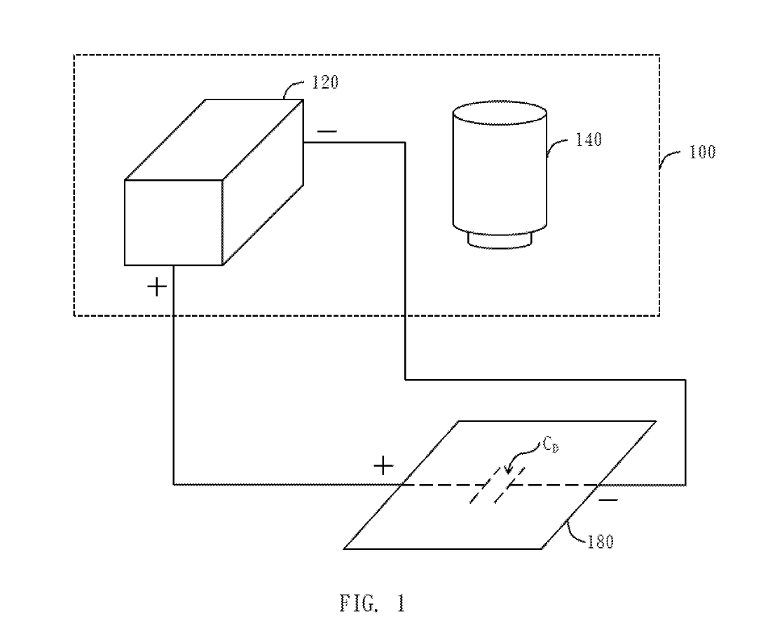

FIG. 1 shows a solar cell inspection apparatus according to an embodiment of the invention. The inspection apparatus 100 can be used to inspect a solar cell 180. The solar cell 180 can be a single solar cell unit, or be a solar cell module that includes multiple solar cell units. In equivalence, the solar cell 180 has a diffusion capacitance C_{D}, which is depicted by the dashed lines, and some other equivalent components not depicted in FIG. 1. The inspection apparatus 100 includes a charging/discharging module 120 and a light detection module 140. The charging/discharging module 120 is operative to first charge and then discharge the diffusion capacitance C_{D}. The light detection module 140 is operative to detect light emitted by the solar cell 180 when the charging/discharging module 120 is discharging the diffusion capacitance C_{D}.

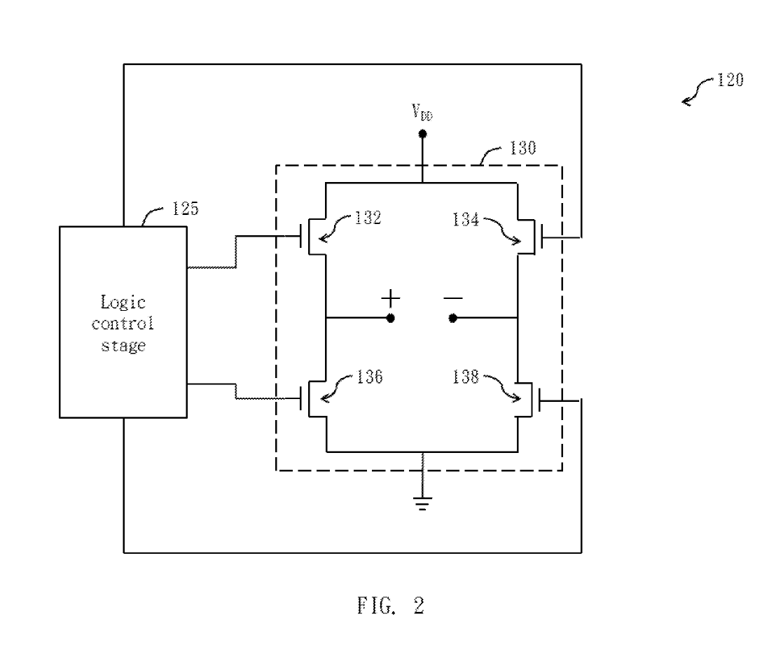

FIG. 2 shows an embodiment of the charging/discharging module 120 of FIG. 1. The charging/discharging module 120 includes a logic control stage 125 and a bridge 130. The bridge 130 includes switches 132, 134, 136, and 138, which can be transistors. The switches 132 and 138 constitute a first set of switches, the switches 134 and 136 constitutes a second set of switches.

The voltage V_{DD} is a DC voltage that is supplied to the charging/discharging module 120. The positive terminal (+) and the negative terminal (−) of the bridge 130 shown in FIG. 2 serve as the positive terminal (+) and the negative terminal (−) of the charging/discharging module 120 shown in FIG. 1, respectively. To charge the diffusion capacitance C_{D}, the logic control stage 125 can turn on the first set of switches 132 and 138 and turn off the second set of switches 134 and 136 so that the first set of switches 132 and 138 can apply a forward DC bias V_{F} across the solar cell 180. On the other hand, to discharge the diffusion capacitance C_{D}, the logic control stage 125 can turn on the second set of switches 134 and 136 and turn off the first set of switches 132 and 138 to enable the second set of switches 134 and 136 to apply a reverse DC bias V_{R} across the solar cell 180. In addition to control these four switches, the logic control stage 125 can further control the operation of the light detection module 140 of FIG. 1, e.g. control the open/close timing of a shutter of the light detection module 140.

The light detection module 140 can be a camera. The light detected by the light detection module 140 during an exposure period is tantamount to the light emission intensity of the solar cell 180 integrated over the exposure period. The light detection module 140 can pass a captured image of the solar cell 180 to another component, and let that component inspect the image and accordingly determine whether the solar cell 180 has any defects.

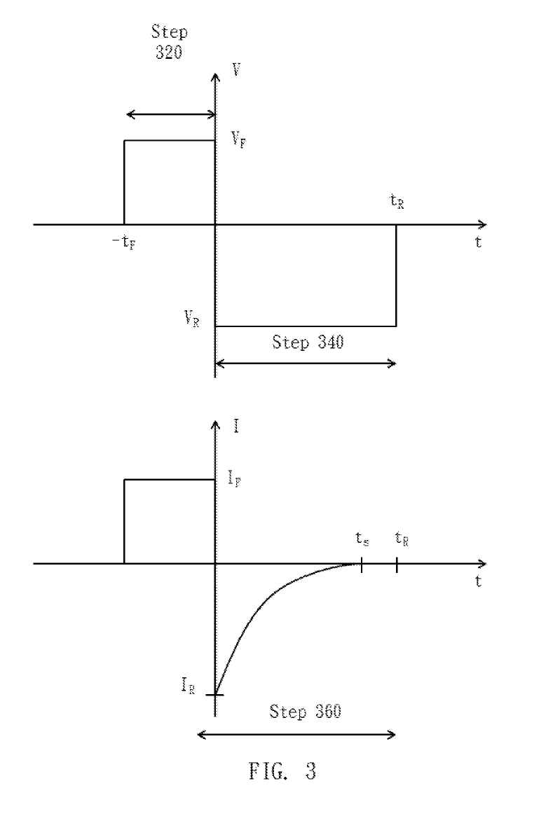

FIG. 3 shows a timing diagram that illustrates a solar cell inspection method according to an embodiment of the invention. The method can be used to inspect the aforementioned solar cell 180. The timing diagram shown in FIG. 3 also serves as an operation example of the solar cell inspection apparatus 100 shown in FIG. 1. Although the apparatus 100 shown in FIG. 1 and the method shown in FIG. 3 are independent to and do not limit each other, the following paragraphs will uses these two figures together to illustrate the components shown in FIG. 1 and the steps shown in FIG. 3.

First, the charging/discharging module 120 charges the diffusion capacitance C_{D} at step 320. As shown in the figure, one way to charge the diffusion capacitance C_{D} is to apply the forward DC bias V_{F} across the solar cell 180, causing a forward DC current to flow through the solar cell 180. The forward DC current is I_{F} on a point of the solar cell 180 with minority carrier lifetime of τₙ. Theoretically, this step should last no shorter than τₙ, and before this step ends the diffusion capacitance on that specific point will accumulate charges amount to I_{F}*τₙ.

Then, the charging/discharging module 120 discharges the diffusion capacitance C_{D} at step 340. As shown in the figure, one way to discharge the diffusion capacitance C_{D} is to apply the reverse DC bias V_{R} across the solar cell 180, causing a gradually reducing reverse DC current to flow through solar cell 180. Theoretically, this step will cause the charges of I_{F}*τₙ accumulated on the point of lifetime τₙ to gradually reduce to zero.

At step 360, the light detection module 140 detects light emitted by the solar cell 180 when the charging/discharging module 120 is discharging the diffusion capacitance C_{D}. The time when step 360 starts should not be later than the time when step 340 starts. If step 360 starts earlier than step 340, the light detection module 140 will additionally detect some of the light emitted by the solar cell 180 during step 320.

At step 320, the physical phenomenon of electroluminescence occurs and the solar cell 180 emits light stably. The light intensity on each point of the solar cell 180 is proportional to the diffusion length DLₙ of that point. The time length of light emission is roughly equal to the time length of step 320. If the light detection module 140 is used to detect light emitted by the solar cell 180 during the whole step 320 or only a part of step 320, the detected light of each point will be proportional to the diffusion length DLₙ of that specific point. However, the difference between the diffusion lengths of normal and abnormal points on the solar cell 180 may not be too large, causing the difference between the light emission intensity of normal and abnormal points to be small as well. As a result, the aforementioned proportional relationship may not be enough to help discerning minor variations of diffusion lengths on different points of the solar cell 180.

At step 340, the physical phenomena of electroluminescence and minority carrier storage time occur and cause the solar cell 180 to emit light briefly. The gradually reducing light intensity on each point is proportional to the diffusion length DLₙ of that specific point. Moreover, as the mathematic deduction hereinafter will show, the time length tₛ of light emission on a point is proportional to the square of the point's diffusion length DLₙ. Therefore, if the light detection module 140 is used to detect the accumulated light emission of the solar cell 180 during step 340, the detected light on each point should be proportional to the third power of the point's diffusion length DLₙ. Because of this relationship, the difference between the detected light emission of normal and abnormal points of the solar cell 180 should be larger for observation. In other words, the proportional relationship between the detected light emission of a point and the third power of the point's diffusion length DLₙ significantly increases the discriminating power of the embodiments.

As the previous two paragraphs have indicated, the period during which steps 360 and 320 overlap with each other gives the aforementioned embodiments ordinary discriminating power. In contrast, the period during which steps 360 and 340 overlap with each other gives the aforementioned embodiments superior discriminating power. Regardless of how these three steps overlap with one another, the aforementioned embodiments should have discriminating power better than that of some other related arts.

The image of the solar cell 180 obtained by the aforementioned embodiments reveals the quality of the solar cell 180. In the image, the points with relatively lower brightness values or with brightness values lower than a threshold are points with shorter diffusion lengths. These relatively darker points may be where defects exist. If the solar cell 180 is a newly manufactured product, the manufacturer may classify the solar cell 180, or the solar cell units that contain those darker points, as defective product(s). If the solar cell 180 is already in use, its maintenance personnel may need to replace the solar cell 180, or the solar cell units that contain those darker points.

The following is the mathematic deduction mentioned above. In the deduction, τₙ, is the minority carrier lifetime of a specific point of the solar cell 180, C is the diffusion capacitance of that point, Q is the amount of charges accumulated in the diffusion capacitance C of that point, I is the current flowing through that point, R is the equivalent series resistance of that point, V_{C} is the voltage across the diffusion capacitance C, I_{F} is the forward current flowing through that point during step 320, and I_{R} is the reverse current flowing through that point when step 340 starts.

First,

$$\frac{d Q}{d t} = i - \frac{Q}{{τ}_{n}} \qquad ( 1 )$$

Furthermore, at step 340, the following equations are true as well:

$${V}_{C} = \frac{Q}{C} = R * i - {V}_{R} ;$$

$$i = \frac{Q}{R * C} + \frac{{V}_{R}}{R} .$$

The following equations can be derived by substituting the previous equation into equation (1):

$$\frac{d Q}{d t} = - \frac{Q}{R * C} - \frac{{V}_{R}}{R} - \frac{Q}{{τ}_{n}} ;$$

$$\frac{d Q}{d t} = - {I}_{R} - ( \frac{1}{R * C} + \frac{1}{{τ}_{n}} ) Q ;$$

$$\frac{d Q}{{I}_{R} + ( \frac{1}{R * C} + \frac{1}{{τ}_{n}} ) Q} = - d t ;$$

$${\int }_{Q ( t = 0 )}^{Q ( t = {t}_{s} )} \frac{d Q}{{I}_{R} + ( \frac{1}{R * C} + \frac{1}{{τ}_{n}} ) Q} = - {\int }_{0}^{{t}_{s}} d t ;$$

$$\frac{1}{\frac{1}{R * C} + \frac{1}{{τ}_{n}}} {\int }_{Q ( t = 0 )}^{Q ( t = {t}_{s} )} \frac{d ( {I}_{R} + ( \frac{1}{R * C} + \frac{1}{{τ}_{n}} ) Q )}{{I}_{R} + ( \frac{1}{R * C} + \frac{1}{{τ}_{n}} ) Q} = {t}_{s} ;$$

$${t}_{s} = \frac{1}{\frac{1}{R * C} + \frac{1}{{τ}_{n}}} * ln ( \frac{{I}_{R} + \frac{Q ( 0 )}{{τ}_{n}}}{{I}_{R} + \frac{Q ( {t}_{s} )}{{τ}_{n}}} ) .$$

Because Q(0)=I_{F}*τₙ and Q(tₛ)=0, the previous equation can be re-written as:

$${t}_{s} = \frac{1}{\frac{1}{R * C} + \frac{1}{{τ}_{n}}} * ln ( 1 + \frac{{I}_{F}}{{I}_{R}} ) .$$

As long as R is a proper value that makes R*C much larger than τₙ, the previous equation can be rewritten as:

$${t}_{s} = {τ}_{n} * ln ( 1 + \frac{{I}_{F}}{{I}_{R}} ) .$$

As shown in the previous equation, the point's illumination time tₛ is proportional to the point's minority carrier lifetime τₙ. Furthermore, because τₙ=DLₙ²/D, the point's illumination time tₛ is proportional to the square of the point's diffusion length DLₙ.

Because the light detection module 140's operation is tantamount to the integration of transient light intensity over exposure time, the brightness of the point in the captured image should be proportional to not only the transient light intensity, but also the exposure time. In other words,

Iᵥ∝I_{R}*tₛ*DLₙ,

where DLₙ=(D*τₙ)^{1/2}.

Furthermore, because tₛ is proportional to τₙ, the previous mathematic expression becomes:

Iᵥ∝τₙ^{3/2}.

As compared with convention inspection methods, in which contrast on brightness is lower because brightness Iᵥ is only proportional to τₙ^{1/2}, the embodiments of the invention can significantly increase the contrast of brightness and the discriminating power.

Please refer to FIG. 3, to increase the discriminating power of the embodiments, step 360 should start no later than the time when step 340 starts, and the overlap in time between steps 360 and 320 should be as short as possible. Furthermore, the time length t_{R} should not be shorter than the maximum of all the possible illumination time tₛ. To arrange the timing of these three steps, the speed limitations of the charging/discharging module 120 and the light detection module 140 should be taken into consideration.

The magnitude order of minority carrier lifetime of the current generation solar cells is roughly 0.001 second or less, and is seldom longer than 0.005 second. Therefore, in the embodiments, both steps 320 and 340 are shorter than 0.005 second. This arrangement can reduce the required inspection time.

Based upon the arrangement mentioned in the previous paragraph, the frequency of the applied voltage is at least 100 Hz, higher than the 60 Hz frequency of regular commercial AC power. Furthermore, the applied voltage has a square waveform, varying between the forward DC bias V_{F} and the reverse DC bias V_{R}. This square wave is different from a sign/cosine waveform. If regular commercial AC power is used to replace the applied voltage shown in FIG. 3, the sign/cosine waveform and the low frequency will reduce the discriminating power and prolong the required inspection time.

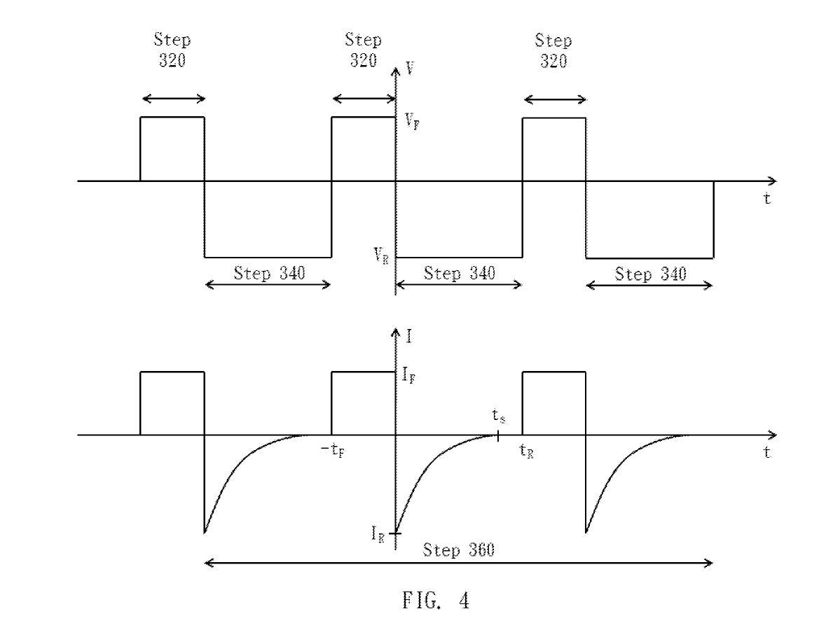

FIG. 3 can be modified to become FIG. 4 to extend the inspection time of step 360. In FIG. 4, step 320 and step 340 are performed alternately for more than once. The inspection time of step 360 is longer than a single period of steps 320 and 340. In addition, in FIG. 4, the length t_{F} of each step 320 can be shorter than the length t_{R} of each step 340. Furthermore, the overlap between step 360 and step 340 should amount to as much of the overall time of step 360 as possible.

Moreover, appropriate control of environmental parameters (such as temperature and moisture) can be combined with the embodiments of the invention to further improve the discriminating power and reliability of inspection.

In contrast to inspection methods that apply the theory of EBIC or LBIC, the aforementioned embodiments are more suitable for practical application because they have lower inspection costs, higher inspection speeds, and better discriminating power, and require inspection machines of smaller volumes. In contrast to other inspection methods that apply the theory of EL, the aforementioned embodiments have better discriminating power and hence can more precisely discern defects on solar cells.

In the foregoing detailed description, the invention has been described with reference to specific exemplary embodiments thereof. It will be evident that various modifications may be made thereto without departing from the spirit and scope of the invention as set forth in the following claims. The detailed description and drawings are, accordingly, to be regarded in an illustrative sense rather than a restrictive sense.

What is claimed is:

1. A solar cell inspection method, comprising:
charging a diffusion capacitance of a solar cell;
after charging the diffusion capacitance, discharging the diffusion capacitance; and
detecting light emitted by the solar cell during the discharging step.

2. The solar cell inspection method of claim 1, wherein the discharging step comprises applying a reverse DC bias across the solar cell to discharge the diffusion capacitance.

3. The solar cell inspection method of claim 1, wherein the charging step comprises applying a forward DC bias across the solar cell to charge the diffusion capacitance, and the discharging step comprises applying a reverse DC bias across the solar cell to discharge the diffusion capacitance.

4. The solar cell inspection method of claim 1, wherein the charging step lasts shorter than the discharging step.

5. The solar cell inspection method of claim 1, wherein both the charging step and the discharging step are shorter than 0.005 second.

6. A solar cell inspection method, comprising:
applying a forward DC bias across a solar cell;
after applying the forward DC bias, applying a reverse DC bias across the solar cell; and
detecting light emitted by the solar cell when the reverse DC bias is being applied.

7. The solar cell inspection method of claim 6, wherein the step of applying the forward DC bias lasts shorter than the step of applying the reverse DC bias.

8. The solar cell inspection method of claim 6, wherein both the step of applying the forward DC bias and the step of applying the reverse DC bias are shorter than 0.005 second.

9. A solar cell inspection apparatus, comprising:
a charging/discharging module, operative to first charge and then discharge a diffusion capacitance of a solar cell; and
a light detection module, operative to detect light emitted by the solar cell when the charging/discharging module is discharging the diffusion capacitance.

10. The solar cell inspection apparatus of claim 9, wherein the charging/discharging module is operative to apply a reverse DC bias across the solar cell to discharge the diffusion capacitance.

11. The solar cell inspection apparatus of claim 9, wherein the charging/discharging module is operative to apply a forward DC bias across the solar cell to charge the diffusion capacitance, and then apply a reverse DC bias across the solar cell to discharge the diffusion capacitance.

12. The solar cell inspection apparatus of claim 9, wherein the charging/discharging module comprises:
a logic control stage; and
a bridge, comprising a first set of switches and a second set of switches to be coupled to the solar cell;
wherein the logic control stage is operative to turn on the first set of switches and turn off the second set of switches so as to let the first set of switches charge the diffusion capacitance by applying a forward DC bias across the solar cell, or to turn on the second set of switches and turn off the first set of switches so as to let the second set of switches discharge the diffusion capacitance by applying a reverse DC bias across the solar cell.
